(19) United States
(12) Patent Application Publication
(10) Pub. No.: US 2013/0304244 A1
(43) Pub. Date: Nov. 14, 2013

(54) AUDIO ALIGNMENT APPARATUS

(71) Applicant: Juha Ojanperä, Nokia (FI)

(72) Inventor: Juha Ojanperä, Nokia (FI)

(73) Assignee: Nokia Corporation, Espoo (FI)

(21) Appl. No.: 13/980,131

(22) PCT Filed: Jan. 20, 2011
(86) PCT No.: PCT/IB2011/050257

§ 371 Date: Jul. 17, 2013

(51) Int. Cl. G06F 17/30

(52) U.S. Cl. CPC G06F 17/3074
USPC 700/94

(57) ABSTRACT

Apparatus comprising: a pairwise selector configured to organise at least one pairwise selection of each of at least two audio signals; a comparator configured to determine for each of the at least one pairwise selection audio signals a time offset value associated with each audio signal; and a delay determiner configured to determine a leading audio signal dependent on the each of the pairwise selection audio signal time offset value, wherein the leading audio signal leads the other audio signals.

### FIELD OF THE APPLICATION

The present application relates to apparatus for the processing of audio and additionally video signals. The invention further relates to, but is not limited to, apparatus for processing audio and additionally video signals from mobile devices.

### BACKGROUND OF THE APPLICATION

Viewing recorded or streamed audio-video or audio content is well known. Commercial broadcasters covering an event often have more than one recording device (video-camera/microphone) and a programme director will select a ‘mix’ where an output from a recording device or combination of recording devices is selected for transmission.

Multiple ‘feeds’ may be found in sharing services for video and audio signals (such as those employed by YouTube). Such systems, which are known and are widely used to share user generated content recorded and uploaded or up-streamed to a server and then downloaded or down-streamed to a viewing/listening user. Such systems rely on users recording and uploading or up-streaming a recording of an event using the recording facilities at hand to the user. This may typically be in the form of the camera and microphone arrangement of a mobile device such as a mobile phone.

Often the event is attended and recorded from more than one position by different recording users at the same time. The viewing/listening end user may then select one of the up-streamed or uploaded data to view or listen.

Where there is multiple user generated content for the same event it can be possible to generate an improved content rendering of the event by combining various different recordings from different users or improve upon user generated content from a single source, for example reducing background noise by mixing different users content to attempt to overcome local interference, or uploading errors.

There can be a problem in multiple user generated or recorded systems where the recording devices are in close proximity and the same audio scene is recorded multiple times. Typically the recordings are performed in an unsynchronized manner. In other words there is no external synchronization that maintains the different recordings synchronized. As each user independently records and upstreams the content to the server, the time delay associated with this process for each recording is not constant. The time delay can be introduced in the processing of the recorded sensor data (audio, video), in the transmission over the network to the server (network jitter), and even in the user recording and later uploading the signal when the recording is complete.

In order that the audio server can provide the best user experience it is necessary that the signals that have been recorded and upstreamed to the server independently are synchronized. Furthermore it can be of utmost importance that when aligning content the correct content gets assigned as the minimum delay content, that is, all the remaining content is delayed with respect to this content.

It is known that synchronization can be achieved by using a dedicated synchronization signal to time stamp the recordings. The synchronization signal can for example be some special beacon signal or common timing information available to all of the recording devices, for example, a timing stamp obtained through GPS satellites which is sent with the audio (and audio-visual data) which can be used to establish a time delay between the audio signals received. The use of a beacon signal typically requires special hardware and/or software which limits the applicability to multi-user sharing service (for example the recording devices are more expensive and thus can be too expensive for mass use or limit the use of existing devices for such new services). For example a GPS receiver associated with the recording device could be used for synchronization as it provides a common and reliable timing signal which could be encoded along with the audio signal to enable audio signal alignment. However not only does the employment of GPS receiver technology increase the cost of the recording device, increase the power consumption of the device and furthermore decrease the coding efficiency of the device as the timing stream bits have to be inserted into the audio signal passed from the recording device to the audio server but the GPS receiver can produce poor results when used in built up or indoor environments.

Furthermore signal synchronization using correlation methods have been found to poorly performing as they do not fit well to the multi-device environment since the number of recordings causes the number of correlation calculations to increase exponentially rather than linearly. Furthermore, it has been shown to be extremely difficult to derive the minimum delay recording from the correlation matrix in any reliable manner.

### SUMMARY OF THE APPLICATION

Aspects of this application thus provide an audio alignment process whereby multiple devices can be present and recording audio signals whereby a server can align of audio signals from the uploaded data.

There is provided according to the application an apparatus comprising at least one processor and at least one memory including computer code, the at least one memory and the computer code configured to with the at least one processor cause the apparatus to at least perform: at least one pairwise selection of each of at least two audio signals; determining for each of the at least one pairwise selection audio signals a time offset value associated with each audio signal; and determining a leading audio signal dependent on the each of the pairwise selection audio signal time offset value, wherein the leading audio signal leads the other audio signals.

The apparatus may be further caused to perform determining a timing offset value associated with each of the audio signals with respect to the leading audio signal.

Determining for each of the at least one pairwise selection of audio signals a time offset value associated with each audio signal may cause the apparatus to perform: determining a relative time offset value between each pairwise selection of the at least one pairwise selection of audio signals; and determining the directionality of the relative time offset value.

Determining the directionality of the relative time offset value may cause the apparatus to determine which of the pairwise selection of audio signals leads the other.

Determining for each of the at least one pairwise selection of audio signals a time offset value associated with each audio signal further may cause the apparatus to perform: determining at least one time offset value is an error value; and removing the at least one time offset value error value.

Determining at least one time offset value is an error value may cause the apparatus to perform: generating an average offset value associated with an audio signal; determining a difference between the error time offset value and average offset value associated with the audio signal; comparing the difference against a difference threshold; and determining the at least one time offset value is an error value when the difference value is greater than or equal to the difference threshold.

The difference threshold may be the variance of the offset values associated with the audio signal.

The at least one pairwise selection of each of the audio signals may cause the apparatus to perform: a first pairwise selection of each of the audio signals; and at least one further pairwise selection of each of the audio signals.

The first pairwise selection of each of the audio signals may cause the apparatus to perform: selecting an initial audio signal from the at least two audio signals; selecting a second audio signal from the at least two audio signals to form a pair of audio signals; and selecting further pairs of audio signal until each audio signal is selected, where the further pairs of audio signals may comprise an audio signal from a previous selection pair of audio signals which leads a further audio signal from the previous selection pair of audio signals.

Each of the at least one further pairwise selection of each of the audio signals may cause the apparatus to perform: selecting a further initial audio signal from the at least two audio signals, wherein the further initial audio signal differs from any previous initial audio signal; and selecting a further second audio signal from the at least two audio signals to form a pair of audio signals.

Determining a leading audio signal dependent on the each of the pairwise selection of audio signal time offset values may cause the apparatus to select the audio signal with a smallest associated time offset value.

According to a second aspect of the application there is provided a method comprising: organising at least one pairwise selection of each of at least two audio signals; determining for each of the at least one pairwise selection audio signals a time offset value associated with each audio signal; and determining a leading audio signal dependent on the each of the pairwise selection audio signal time offset value, wherein the leading audio signal leads the other audio signals.

The method may further comprise determining a timing offset value associated with each of the audio signals with respect to the leading audio signal.

Determining for each of the at least one pairwise selection of audio signals a time offset value associated with each audio signal may comprise: determining a relative time offset value between each pairwise selection of the at least one pairwise selection of audio signals; and determining the directionality of the relative time offset value.

Determining the directionality of the relative time offset value may comprise determining which of the pairwise selection of audio signals leads the other.

Determining for each of the at least one pairwise selection of audio signals a time offset value associated with each audio signal may further comprise: determining at least one time offset value is an error value; and removing the at least one time offset value error value.

Determining at least one time offset value is an error value may comprise: generating an average offset value associated with an audio signal; determining a difference between the error time offset value and average offset value associated with the audio signal; comparing the difference against a difference threshold; and determining the at least one time offset value is an error value when the difference value is greater than or equal to the difference threshold.

The difference threshold may be the variance of the offset values associated with the audio signal.

Organising the at least one pairwise selection of each of the audio signals may comprise: organising a first pairwise selection of each of the audio signals; and organising at least one further pairwise selection of each of the audio signals.

Organising the first pairwise selection of each of the audio signals may comprise: selecting an initial audio signal from the at least two audio signals; selecting a second audio signal from the at least two audio signals to form a pair of audio signals; and selecting further pairs of audio signal until each audio signal is selected, where the further pairs of audio signals comprises an audio signal from a previous selection pair of audio signals which leads a further audio signal from the previous selection pair of audio signals.

Organising each of the at least one further pairwise selection of each of the audio signals may comprise: selecting a further initial audio signal from the at least two audio signals, wherein the further initial audio signal differs from any previous initial audio signal; and selecting a further second audio signal from the at least two audio signals to form a pair of audio signals.

Determining a leading audio signal dependent on the each of the pairwise selection of audio signal time offset values may comprise selecting the audio signal with a smallest associated time offset value.

According to a third aspect of the application there is provided an apparatus comprising: a pairwise selector configured to organise at least one pairwise selection of each of at least two audio signals; a comparator configured to determine for each of the at least one pairwise selection audio signals a time offset value associated with each audio signal; and a delay determiner configured to determine a leading audio signal dependent on the each of the pairwise selection audio signal time offset value, wherein the leading audio signal leads the other audio signals.

The delay determiner may be further configured to determine a timing offset value associated with each of the audio signals with respect to the leading audio signal.

The comparator may comprise a relative comparator configured to determine a relative time offset value between each pairwise selection of the at least one pairwise selection of audio signals; and the directionality of the relative time offset value

The relative comparator may comprise a signal determiner configured to determine which of the pairwise selection of audio signals leads the other.

The comparator may comprise: an outlier determiner configured to determine at least one time offset value is an error value; and an outlier remover configured to remove the at least one time offset value error value.

The outlier determiner may comprise: an offset averager configured to generate an average offset value associated with an audio signal; an offset difference generator configured to determine a difference between the error time offset value and average offset value associated with the audio signal; and an offset comparator configured to compare the difference against a difference threshold and determine the at least one time offset value is an error value when the difference value is greater than or equal to the difference threshold.

The difference threshold may be the variance of the offset values associated with the audio signal.

The pairwise selector may comprise: an initial pairwise selector configured to organise a first pairwise selection of each of the audio signals; and a succeeding pairwise selector configured to organise at least one further pairwise selection of each of the audio signals.

The initial pairwise selector may comprise: a first pair selector configured to select an initial audio signal from the at least two audio signals and a second audio signal from the at least two audio signals to form a pair of audio signals; and a further pair selector configured to select further pairs of audio signal until each audio signal is selected, where the further pairs of audio signals comprise an audio signal from a previous selection pair of audio signals which leads a further audio signal from the previous selection pair of audio signals.

The further pair selector may comprise: a new signal selector configured to select a further initial audio signal from the at least two audio signals, wherein the further initial audio signal differs from any previous initial audio signal; and a previous signal selector configured to select a further second audio signal from the at least two audio signals to form a pair of audio signals.

The delay determiner may comprise a minimum delay determiner configured to select the audio signal with a smallest associated time offset value.

According to a fourth aspect of the application there is provided an apparatus comprising: means for organising at least one pairwise selection of each of at least two audio signals; means for determining for each of the at least one pairwise selection audio signals a time offset value associated with each audio signal; and means for determining a leading audio signal dependent on the each of the pairwise selection audio signal time offset value, wherein the leading audio signal leads the other audio signals.

The apparatus may further comprise means for determining a timing offset value associated with each of the audio signals with respect to the leading audio signal.

The means for determining for each of the at least one pairwise selection of audio signals a time offset value associated with each audio signal may comprise: means for determining a relative time offset value between each pairwise selection of the at least one pairwise selection of audio signals; and means for determining the directionality of the relative time offset value.

The means for determining the directionality of the relative time offset value may comprise means for determining which of the pairwise selection of audio signals leads the other.

The means for determining for each of the at least one pairwise selection of audio signals a time offset value associated with each audio signal may further comprise: means for determining at least one time offset value is an error value; and means for removing the at least one time offset value error value.

The means for determining at least one time offset value is an error value may comprise: means for generating an average offset value associated with an audio signal; means for determining a difference between the error time offset value and average offset value associated with the audio signal; means for comparing the difference against a difference threshold; and means for determining the at least one time offset value is an error value when the difference value is greater than or equal to the difference threshold.

The difference threshold may be the variance of the offset values associated with the audio signal.

The means for organising the at least one pairwise selection of each of the audio signals may comprise: means for organising a first pairwise selection of each of the audio signals; and means for organising at least one further pairwise selection of each of the audio signals.

The means for organising the first pairwise selection of each of the audio signals may comprise: means for selecting an initial audio signal from the at least two audio signals; means for selecting a second audio signal from the at least two audio signals to form a pair of audio signals; and means for selecting further pairs of audio signal until each audio signal is selected, where the further pairs of audio signals comprises an audio signal from a previous selection pair of audio signals which leads a further audio signal from the previous selection pair of audio signals.

The means for organising each of the at least one further pairwise selection of each of the audio signals may comprise: means for selecting a further initial audio signal from the at least two audio signals, wherein the further initial audio signal differs from any previous initial audio signal; and means for selecting a further second audio signal from the at least two audio signals to form a pair of audio signals.

The means for determining a leading audio signal dependent on the each of the pairwise selection of audio signal time offset values may comprise means for selecting the audio signal with a smallest associated time offset value.

There is provided according to a fifth aspect a computer program comprising: code for organising at least one pairwise selection of each of at least two audio signals; code for determining for each of the at least one pairwise selection audio signals a time offset value associated with each audio signal; and code for determining a leading audio signal dependent on the each of the pairwise selection audio signal time offset value, wherein the leading audio signal leads the other audio signals.

The computer program may further comprise code for determining a timing offset value associated with each of the audio signals with respect to the leading audio signal.

The code for determining for each of the at least one pairwise selection of audio signals a time offset value associated with each audio signal may comprise: code for determining a relative time offset value between each pairwise selection of the at least one pairwise selection of audio signals; and code for determining the directionality of the relative time offset value.

The code for determining the directionality of the relative time offset value may comprise code for determining which of the pairwise selection of audio signals leads the other.

The code for determining for each of the at least one pairwise selection of audio signals a time offset value associated with each audio signal may further comprise: code for determining at least one time offset value is an error value; and code for removing the at least one time offset value error value.

The code for determining at least one time offset value is an error value may comprise: code for generating an average offset value associated with an audio signal; code for determining a difference between the error time offset value and average offset value associated with the audio signal; code for comparing the difference against a difference threshold; and code for determining the at least one time offset value is an error value when the difference value is greater than or equal to the difference threshold.

The difference threshold may be the variance of the offset values associated with the audio signal.

The code for organising the at least one pairwise selection of each of the audio signals may comprise: code for organising a first pairwise selection of each of the audio signals; and code for organising at least one further pairwise selection of each of the audio signals.

The code for organising the first pairwise selection of each of the audio signals may comprise: code for selecting an initial audio signal from the at least two audio signals; code for selecting a second audio signal from the at least two audio signals to form a pair of audio signals; and code for selecting further pairs of audio signal until each audio signal is selected, where the further pairs of audio signals comprises an audio signal from a previous selection pair of audio signals which leads a further audio signal from the previous selection pair of audio signals.

The code for organising each of the at least one further pairwise selection of each of the audio signals may comprise: code for selecting a further initial audio signal from the at least two audio signals, wherein the further initial audio signal differs from any previous initial audio signal; and code for selecting a further second audio signal from the at least two audio signals to form a pair of audio signals.

The code for determining a leading audio signal dependent on the each of the pairwise selection of audio signal time offset values may comprise code for selecting the audio signal with a smallest associated time offset value.

An electronic device may comprise apparatus as described above.

A chipset may comprise apparatus as described above.

Embodiments of the present invention aim to address the above problems.

### SUMMARY OF THE FIGURES

For better understanding of the present application, reference will now be made by way of example to the accompanying drawings in which:

FIG. 1 shows schematically a multi-user free-viewpoint service sharing system which may encompass embodiments of the application;

FIG. 2 shows schematically an apparatus suitable for being employed in embodiments of the application;

FIG. 3 shows schematically an audio alignment system according to some embodiments of the application;

FIG. 4 shows schematically audio signal alignment according to some embodiments of the application;

FIG. 5 shows schematically the audio aligner as shown in FIG. 3 in further detail;

FIG. 6 shows a flow diagram of the operation of the audio aligner according to some embodiments;

FIG. 7 shows schematically the pairwise matcher according to some embodiments of the application; and

FIG. 8 shows a flow diagram of the operation of the pairwise matcher according to some embodiments.

### EMBODIMENTS OF THE APPLICATION

The following describes in further detail suitable apparatus and possible mechanisms for the provision of effective synchronisation for audio. In the following examples audio signals and audio capture uploading and downloading is described. However it would be appreciated that in some embodiments the audio signal/audio capture, uploading and downloading is one part of an audio-video system.

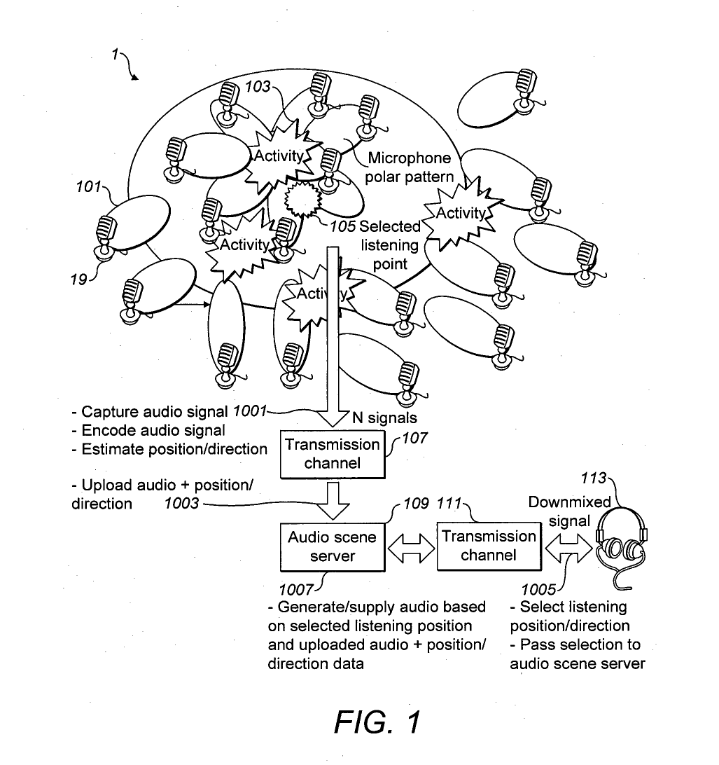

With respect to FIG. 1 an overview of a suitable system within which embodiments of the application can be located is shown. The audio space 1 can have located within it at least one recording or capturing devices or apparatus 19 which are arbitrarily positioned within the audio space to record suitable audio scenes. The apparatus shown in FIG. 1 are represented as microphones with a polar gain pattern 101 showing the directional audio capture gain associated with each apparatus. The apparatus 19 in FIG. 1 are shown such that some of the apparatus are capable of attempting to capture the audio scene or activity 103 within the audio space. The activity 103 can be any event the user of the apparatus wishes to capture. For example the event could be a music event or audio of a news worthy event. The apparatus 19 although being shown having a directional microphone gain pattern 101 would be appreciated that in some embodiments the microphone or microphone array of the recording apparatus 19 has a omnidirectional gain or different gain profile to that shown in FIG. 1.

Each recording apparatus 19 can in some embodiments transmit or alternatively store for later consumption the captured audio signals via a transmission channel 107 to an audio scene server 109. The recording apparatus 19 in some embodiments can encode the audio signal to compress the audio signal in a known way in order to reduce the bandwidth required in “uploading” the audio signal to the audio scene server 109.

The recording apparatus 19 in some embodiments can be configured to estimate and upload via the transmission channel 107 to the audio scene server 109 an estimation of the location and/or the orientation or direction of the apparatus. The position information can be obtained, for example, using GPS coordinates, cell-ID or a-GPS or any other suitable location estimation methods and the orientation/direction can be obtained, for example using a digital compass, accelerometer, or gyroscope information.

In some embodiments the recording apparatus 19 can be configured to capture or record one or more audio signals for example the apparatus in some embodiments have multiple microphones each configured to capture the audio signal from different directions. In such embodiments the recording device or apparatus 19 can record and provide more than one signal from different the direction/orientations and further supply position/direction information for each signal.

The capturing and encoding of the audio signal and the estimation of the position/direction of the apparatus is shown in FIG. 1 by step 1001.

The uploading of the audio and position/direction estimate to the audio scene server is shown in FIG. 1 by step 1003.

The audio scene server 109 furthermore can in some embodiments communicate via a further transmission channel 111 to a listening device 113.

In some embodiments the listening device 113, which is represented in FIG. 1 by a set of headphones, can prior to or during downloading via the further transmission channel 111 select a listening point, in other words select a position such as indicated in FIG. 1 by the selected listening point 105. In such embodiments the listening device 113 can communicate via the further transmission channel 111 to the audio scene server 109 the request.

The selection of a listening position by the listening device 113 is shown in FIG. 1 by step 1005.

The audio scene server 109 can as discussed above in some embodiments receive from each of the recording apparatus 19 an approximation or estimation of the location and/or direction of the recording apparatus 19. The audio scene server 109 can in some embodiments from the various captured audio signals from recording apparatus 19 produce a composite audio signal representing the desired listening position and the composite audio signal can be passed via the further transmission channel 111 to the listening device 113. In some embodiments the audio scene server 109 can be configured to select captured audio signals from the apparatus “closest” to the desired or selected listening point, and to transmit these to the listening device 113 via the further transmission channel 111.

The generation or supply of a suitable audio signal based on the selected listening position indicator is shown in FIG. 1 by step 1007.

In some embodiments the listening device 113 can request a multiple channel audio signal or a mono-channel audio signal. This request can in some embodiments be received by the audio scene server 109 which can generate the requested multiple channel data.

The audio scene server 109 in some embodiments can receive each uploaded audio signal and can keep track of the positions and the associated direction/orientation associated with each audio signal. In some embodiments the audio scene server 109 can provide a high level coordinate system which corresponds to locations where the uploaded/upstreamed content source is available to the listening device 113. The “high level” coordinates can be provided for example as a map to the listening device 113 for selection of the listening position. The listening device (end user or an application used by the end user) can in such embodiments be responsible for determining or selecting the listening position and sending this information to the audio scene server 107. The audio scene server 107 can in some embodiments receive the selection/determination and transmit the downmixed signal corresponding to the specified location to the listening device. In some embodiments the listening device/end user can be configured to select or determine other aspects of the desired audio signal, for example signal quality, number of channels of audio desired, etc. In some embodiments the audio scene server 107 can provide in some embodiments a selected set of downmixed signals which correspond to listening points neighbouring the desired location/direction and the listening device 113 selects the audio signal desired.

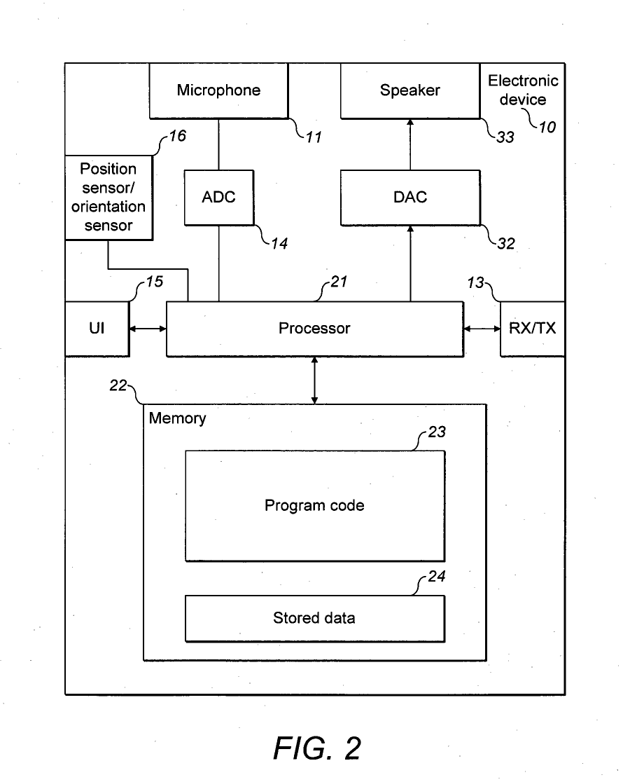

In this regard reference is first made to FIG. 2 which shows a schematic block diagram of an exemplary apparatus or electronic device 10, which may be used to record (or operate as a recording device 19) or listen (or operate as a listening device 113) to the audio signals (and similarly to record or view the audio-visual images and data). Furthermore in some embodiments the apparatus or electronic device can function as the audio scene server 811.

The electronic device 10 may for example be a mobile terminal or user equipment of a wireless communication system when functioning as the recording device or listening device 813. In some embodiments the apparatus can be an audio player or audio recorder, such as an MP3 player, a media recorder/player (also known as an MP4 player), or any suitable portable device suitable for recording audio or audio/video camcorder/memory audio or video recorder.

The apparatus 10 can in some embodiments comprise an audio subsystem. The audio subsystem for example can comprise in some embodiments a microphone or array of microphones 11 for audio signal capture. In some embodiments the microphone or array of microphones can be a solid state microphone, in other words capable of capturing audio signals and outputting a suitable digital format signal. In some other embodiments the microphone or array of microphones 11 can comprise any suitable microphone or audio capture means, for example a condenser microphone, capacitor microphone, electrostatic microphone, Electret condenser microphone, dynamic microphone, ribbon microphone, carbon microphone, piezoelectric microphone, or microelectrical-mechanical system (MEMS) microphone. The microphone 11 or array of microphones can in some embodiments output the audio captured signal to an analogue-to-digital converter (ADC) 14.

In some embodiments the apparatus can further comprise an analogue-to-digital converter (ADC) 14 configured to receive the analogue captured audio signal from the microphones and outputting the audio captured signal in a suitable digital form. The analogue-to-digital converter 14 can be any suitable analogue-to-digital conversion or processing means.

In some embodiments the apparatus 10 audio subsystem further comprises a digital-to-analogue converter 32 for converting digital audio signals from a processor 21 to a suitable analogue format. The digital-to-analogue converter (DAC) or signal processing means 32 can in some embodiments be any suitable DAC technology.

Furthermore the audio subsystem can comprise in some embodiments a speaker 33. The speaker 33 can in some embodiments receive the output from the digital-to-analogue converter 32 and present the analogue audio signal to the user. In some embodiments the speaker 33 can be representative of a headset, for example a set of headphones, or cordless headphones.

Although the apparatus 10 is shown having both audio capture and audio presentation components, it would be understood that in some embodiments the apparatus 10 can comprise one or the other of the audio capture and audio presentation parts of the audio subsystem such that in some embodiments of the apparatus the microphone (for audio capture) or the speaker (for audio presentation) are present.

In some embodiments the apparatus 10 comprises a processor 21. The processor 21 is coupled to the audio subsystem and specifically in some examples the analogue-to-digital converter 14 for receiving digital signals representing audio signals from the microphone 11, and the digital-to-analogue converter (DAC) 12 configured to output processed digital audio signals. The processor 21 can be configured to execute various program codes. The implemented program codes can comprise for example audio encoding code routines.

In some embodiments the apparatus further comprises a memory 22. In some embodiments the processor is coupled to memory 22. The memory can be any suitable storage means. In some embodiments the memory 22 comprises a program code section 23 for storing program codes implementable upon the processor 21. Furthermore in some embodiments the memory 22 can further comprise a stored data section 24 for storing data, for example data that has been encoded in accordance with the application or data to be encoded via the application embodiments as described later. The implemented program code stored within the program code section 23, and the data stored within the stored data section 24 can be retrieved by the processor 21 whenever needed via the memory-processor coupling.

In some further embodiments the apparatus 10 can comprise a user interface 15. The user interface 15 can be coupled in some embodiments to the processor 21. In some embodiments the processor can control the operation of the user interface and receive inputs from the user interface 15. In some embodiments the user interface 15 can enable a user to input commands to the electronic device or apparatus 10, for example via a keypad, and/or to obtain information from the apparatus 10, for example via a display which is part of the user interface 15. The user interface 15 can in some embodiments comprise a touch screen or touch interface capable of both enabling information to be entered to the apparatus 10 and further displaying information to the user of the apparatus 10.

In some embodiments the apparatus further comprises a transceiver 13, the transceiver in such embodiments can be coupled to the processor and configured to enable a communication with other apparatus or electronic devices, for example via a wireless communications network. The transceiver 13 or any suitable transceiver or transmitter and/or receiver means can in some embodiments be configured to communicate with other electronic devices or apparatus via a wire or wired coupling.

The coupling can, as shown in FIG. 1, be the transmission channel 107 (where the apparatus is functioning as the recording device 19) or further transmission channel 111 (where the device is functioning as the listening device 113). The transceiver 13 can communicate with further devices by any suitable known communications protocol, for example in some embodiments the transceiver 13 or transceiver means can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

In some embodiments the apparatus comprises a position sensor 16 configured to estimate the position of the apparatus 10. The position sensor 16 can in some embodiments be a satellite positioning sensor such as a GPS (Global Positioning System), GLONASS or Galileo receiver.

In some embodiments the positioning sensor can be a cellular ID system or an assisted GPS system.

In some embodiments the apparatus 10 further comprises a direction or orientation sensor. The orientation/direction sensor can in some embodiments be an electronic compass, accelerometer, a gyroscope or be determined by the motion of the apparatus using the positioning estimate.

It is to be understood again that the structure of the electronic device 10 could be supplemented and varied in many ways.

Furthermore it could be understood that the above apparatus 10 in some embodiments can be operated as an audio scene server 109. In some further embodiments the audio scene server 109 can comprise a processor, memory and transceiver combination.

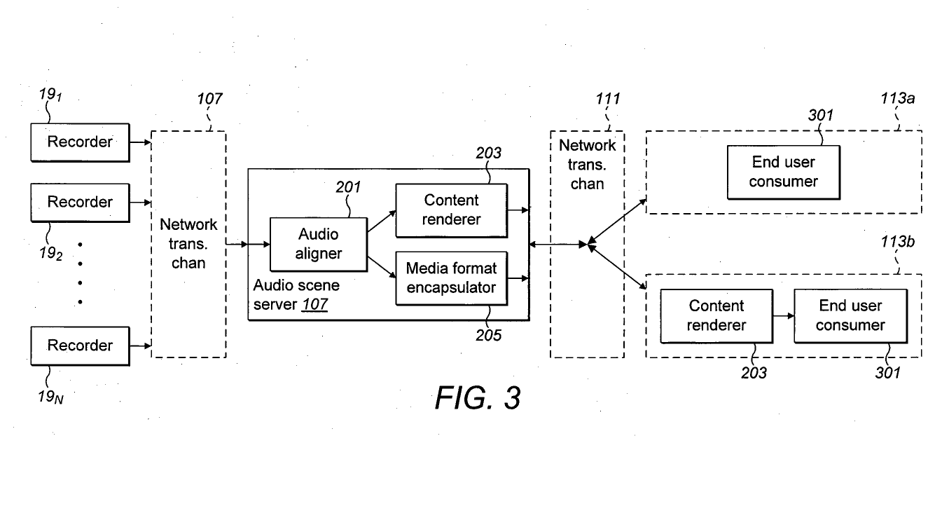

With respect to FIG. 3 the audio alignment system according to some embodiments of the application is shown. The audio alignment system is shown with a plurality of recorders 19₁ 19₂ 19ₙ which using the transmission channel 107 pass audio signals which are being recorded or captured to the audio scene server 107. The audio scene server 107 can then furthermore output via the further transmission channel 111 to listening devices 113_{A} and 113_{B}.

In some embodiments the audio scene server 107 comprises an audio aligner 201 which is configured to receive the audio signals from the recorders via the transmission channel 107. The audio aligner 201 is configured to align the various audio signals in such a way that they can be further processed to provide content to the end user and the listening devices 113. The audio aligner 201 can be configured to output the aligned audio signals audio signals with an associated alignment coefficient to such further processors as a content render 203 and a media format encapsulator 205.

In some embodiments the audio scene server 107 further comprises at least one content renderer 203. The content renderer 203 is configured in some embodiments to prepare the content for end-user consumption. For example the audio signals can be processed in such a way that the multi user audio recordings or signals are processed into a more user friendly representation format and so can be remixed or down mixed into a format suitable for the end user or listening device 113. Thus for example in some embodiments the content renderer 203 generates a stereo audio signal where the end user listening device 113 comprises a stereo headset. The operations carried out by the content renderer 203, for example down mixing or remixing of the audio signals can be carried out in any suitable form and are not discussed further.

In some embodiments the audio scene server 107 comprises a media format encapsulator 205. The media format encapsulator 205 can be configured to compose media format representations which include the various multiuser recorded audio signals and associated time offsets determined by the audio aligner. Thus for example the media format encapsulator 205 can generate media in such a format that it is suitable to be transmitted or passed to the various end-users requesting it and allow the end-user themselves to render the multi user content in whichever way the end user or listening device 113 wishes or requests it to be.

Thus the audio signals having been aligned and processed in a suitable form can be passed via the further transmission channel or network 111 to the listening devices 113.

FIG. 3 shows two suitable listening devices 113_{A} which comprises an end user consumer component 301 which is configured to receive the encapsulated media or rendered content and output the suitable audio signals to the listening device user. Furthermore FIG. 3 shows a listening device 113_{B} which comprises not only the end user consumer 301 but also a content renderer 203 which having received the audio signals and their associated audio alignment parameters can process the audio signals prior to presentation to the user by the listening device 113 in a manner similar to the content renderer on the audio scene server 107 in some embodiments. Thus in some embodiments the audio processing can reside on the audio server 107 or can reside in the local listening device. Furthermore in some embodiments the local listening devices are configured to communicate with each other and can carry out audio processing on a peer-to-peer basis.

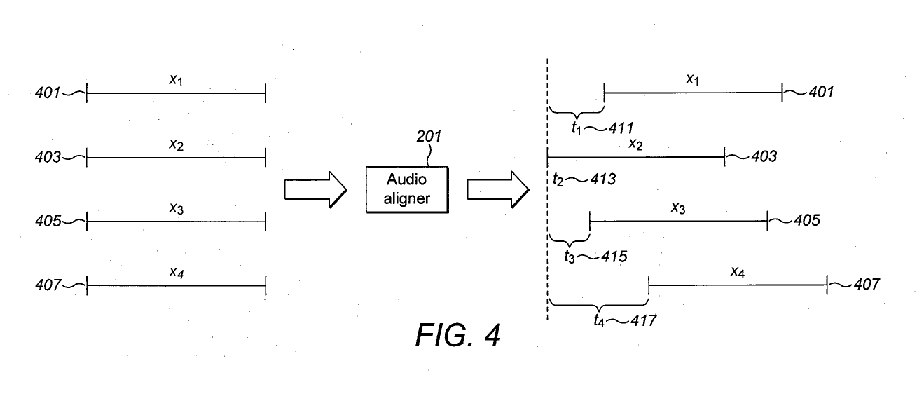

With respect to FIG. 4 an example of the operations of the audio aligner 201 is shown. FIG. 4 for example shows the audio aligner 201 receiving four separate audio signals X₁ 401, X₂ 403, X₃ 405, and X₄ 407. However it would be understood that the audio aligner 201 could receive any suitable number of audio signals with any suitable delay. Thus for example in some embodiments the four audio signals can be received at the audio aligner 201 contemporaneously, in other words they are ‘live’ streamed events passed from the recording devices over the network or transmission channel 107. However it would be understood that any one of these audio signals could be received via the transmission channel 107 at a time later than any one of the other audio signals, in other words that one of the audio signals is uploaded as a ‘live’ audio signal and a further audio signal is a delayed recorded audio signal (in other words uploaded after the recording process is completed or after a suitable length of time of recording such as enabled by network buffering).

The signals shown in FIG. 4 X₁ 401, X₂ 403, X₃ 405, X₄ 407 are shown as having similar lengths however it would be appreciated furthermore that the received signals can have differing lengths. The audio aligner 201 however can be configured to determine a time offset which when applied to each signal enables each signal to share a time stamp. The time offset t indicates the amount of offset required for each of the audio signals such that the first time offset t₁ 411 is the time required to offset the first signal X₁, t₂ the time offset for the second audio signal X₂, t₃ the time offset for the third audio signal X₃ and t₄ the time period required to offset the fourth audio signal X₄. It can be seen that the offset t₂ is equal to 0 in other words that the second signal X₂ 403 can serve as a reference with respect to the other audio signals.

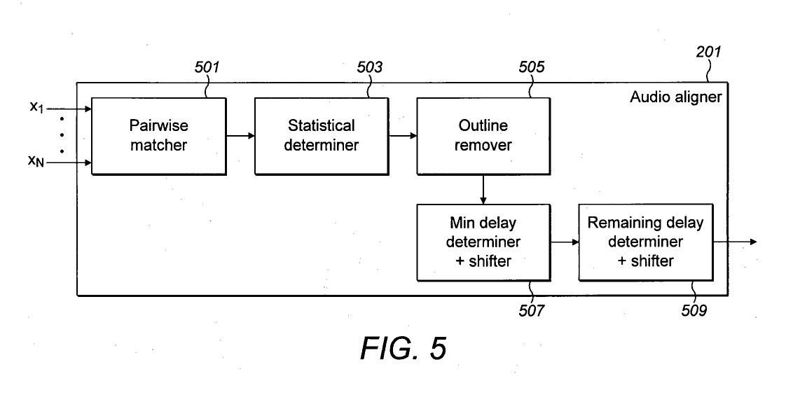

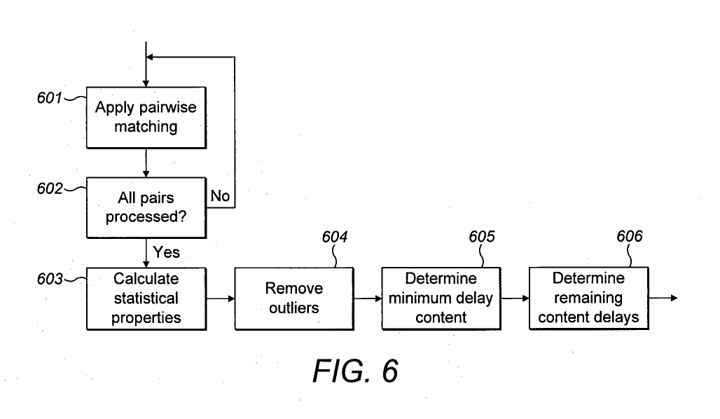

With respect to FIG. 5 the audio aligner 201 is shown in further detail. Furthermore with respect to FIG. 6 the operations of the audio aligner shown with respect to FIG. 5 are shown.

The audio aligner 201 in some embodiments can comprise a pairwise matcher 501. The pairwise matcher is configured to receive the audio signals from the recorders 19 via the transmission channel 107 and time match the signals on a pair by pair basis. The pairwise matcher 501 is described in further detail herein. In other words there can in some embodiments comprise means for organising, or a pairwise selector or matcher configured to organise, at least one pairwise selection of each of at least two audio signals.

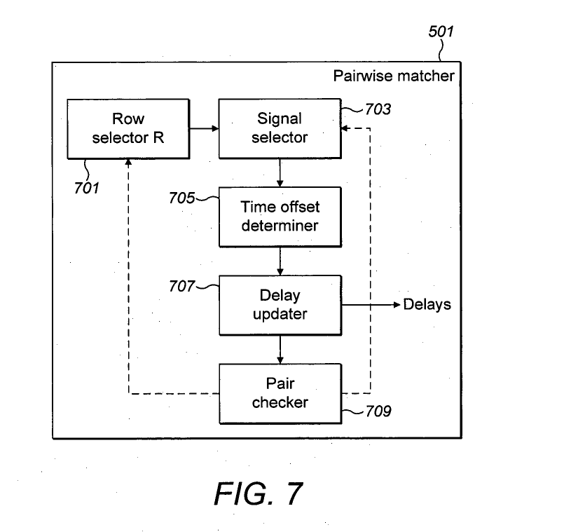

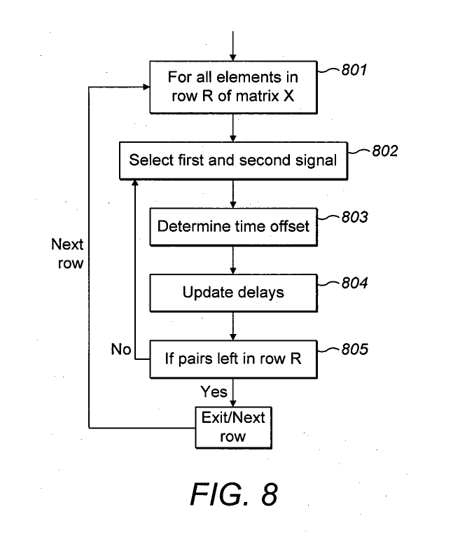

With respect to FIG. 7 the pairwise matcher 501 is shown in further detail. Furthermore with respect to FIG. 8 the operation of the pairwise matcher 501 as shown in FIG. 7 is shown in further detail.

In some embodiments the pairwise matcher 501 comprises a row selector 701. The row selector 701 is configured to select a row from a two-dimensional vector X created from the input signals. This vector has R Rows and N columns where R is less than or equal to N and N the number of input signals.

For example mathematically if the input signals are x₁ . . . x₄. The matrix X is formed according to

$$X = [ \begin{matrix}{x}_{1} & {x}_{2} & {x}_{3} & {x}_{4} \\ {x}_{2} & {x}_{3} & {x}_{4} & {x}_{1} \\ {x}_{3} & {x}_{4} & {x}_{1} & {x}_{2} \\ {x}_{4} & {x}_{1} & {x}_{2} & {x}_{3}\end{matrix} ]$$

In other words each row in matrix X starts with different input signal where the rows 2 to R are circularly shifted versions of the 1^{st} row. For the first iteration of the pairwise matcher the row selector 701 can be configured to select initially the first row, and then on further iterations to select the 2^{nd}, 3^{rd} rows up to the R^{th} row selection on the R^{th} iteration.

The operation of selecting the row is shown in FIG. 8 by step 801.

Furthermore in some embodiments the pairwise matcher 501 comprises a signal selector 703 configured to receive the selected row. The signal selector 703 is configured to select a first and a second of the audio signals from the row to create a signal pair. Thus for a first iteration of the selected row the signal selector 703 can be configured to select signals x₁, x₂. For the further iterations of the selected row the signal selector 703 can be configured to select further new signal pairs and the same following operations are repeated; only the first and second signal within the pair will change. For example in some embodiments where the first signal was delayed with respect to the second signal (in other words the second signal is determined to lead the first signal) the new signal pair will be formed as follows: the new pair first signal is the second signal and the new pair second signal is the succeeding signal of the second signal of the old signal pair. Furthermore in the same embodiments where the second signal is determined to be delayed with respect to the first signal (in other words the second signal is determined to lag the first signal) the new signal pair will be formed as follows: the new first signal remains the same and the new second signal is the succeeding signal or the signal following the second signal of the old signal pair.

Any means for organising the at least one pairwise selection of each of the audio signals in some embodiments can comprise means for organising, or an initial pairwise selector configured to, organise a first pairwise selection of each of the audio signals and means for organising, or a succeeding pairwise selector configured to organise, at least one further pairwise selection of each of the audio signals. Furthermore the initial pairwise selector or means for organising the first pairwise selection of each of the audio signals can in some embodiments comprise means for selecting, or a first pair selector configured to select, an initial audio signal from the at least two audio signals, means for selecting, or a further pair selector configured to select, a second audio signal from the at least two audio signals to form a pair of audio signals and means for selecting further pairs of audio signal until each audio signal is selected, where the further pairs of audio signals comprises an audio signal from a previous selection pair of audio signals which leads a further audio signal from the previous selection pair of audio signals.

The further pair selector or means for organising each of the at least one further pairwise selection of each of the audio signals can in some embodiments comprise means for selecting, or a new signal selector configured to select, a further initial audio signal from the at least two audio signals, wherein the further initial audio signal differs from any previous initial audio signal and means for selecting, or a previous signal selector configured to select, a further second audio signal from the at least two audio signals to form a pair of audio signals.

To illustrate the formation of the signal pairs, the following example pairs can be used.
Example 1: x₁,x₂ x₁,x₃ x₁,x₄
Example 2: x₁,x₂ x₂,x₃ x₂,x₄
Example 3: x₁,x₂ x₂,x₃ x₃,x₄

In the first example, the first signal pair selected is x₁,x₂ and value of trgIdx=1. The time offset (for example) could indicate that the second signal is delayed with respect to the first signal (the second signal x₂ lags the first signal x₁). In some embodiments therefore the next signal pair selected is x₁,x₃ and trgIdx=2. Furthermore continuing the example the time offset for the pair is again such that the ‘new’ second signal is determined as delayed with respect to the ‘new’ first signal (the ‘new’ second signal x₃ of the pair lags the ‘new’ first signal x₁). Therefore, the last pair for this example to be selected is x₁,x₄ and trgIdx=3.

In the second example, the first signal pair selected is x₁,x₂ and trgIdx=1. The time offset in this example determines that the first signal is delayed with respect to the second signal (the second signal x₂ leads the first signal x₁). Therefore the next signal pair selected would be in some embodiments x₂,x₃ and trgIdx=2. Furthermore continuing the example the time offset for the pair is determined such that the ‘new’ second signal is delayed with respect to the ‘new’ first signal (the ‘new’ second signal x₃ of the pair lags the ‘new’ first signal x₂). Therefore, in such embodiments the last pair selected is x₂,x₄ and trgIdx=3.

In the third example, the first signal pair selected is x₁,x₂ and trgIdx=1. The time offset in this example is determined to indicate that the first signal is delayed with respect to the second signal (the second signal x₂ lags the first signal x₁). Therefore the next signal pair selected would be in some embodiments x₂,x₃ and trgIdx=2. Furthermore continuing the example the time offset for the pair is again determined such that the ‘new’ first signal is delayed with respect to the ‘new’ second signal (the ‘new’ second signal x₃ of the pair leads the ‘new’ first signal x₂). Therefore, in such embodiments the last pair selected is x₃,x₄ and trgIdx=3.

The operation of selecting a first and a second signal from the row to create a signal pair is shown in FIG. 8 by step 802.

Furthermore the pairwise matcher 501 can comprise a time offset determiner 705. The time offset determiner 705 is configured to determine the time offset for the signal pair. The time offset determiner 705 can apply any suitable time offset determination method to determine the time offset between the two signals and to which of the signals within the pair the time offset should be applied, that is, should the first signal be delayed with respect to the second signal or vice versa. A suitable time offset determination apparatus or method for example is that used in GB published application 2470201. Thus in some embodiments there can comprise means for determining, or a comparator configured to determine, for each of the at least one pairwise selection audio signals a time offset value associated with each audio signal. Furthermore in some embodiments the comparator or means for determining a time offset value can comprise means for determining, or a relative comparator configured to determine, a relative time offset value between each pairwise selection of the at least one pairwise selection of audio signals and means for determining the directionality of the relative time offset value. The relative comparator or means for determining the directionality of the relative time offset value can in some embodiments comprise means for determining, or be configured to determine, which of the pairwise selection of audio signals leads the other.

The operation of determining the time offset of the pair of signals is shown in FIG. 8 by step 803.

The pairwise matcher 501 can further comprise in some embodiments a delay updater 707 which is configured to update the delay parameters such that based on the calculated time offset for the signal pair the time offset for each signal up to the first signal location or the time offset of the second signal within the selected row can then be updated.

Initially, the time offset of each signal in the selected row is set to a zero value. Where it has been found that it is the first signal that is to be delayed with respect to the second signal the delay updater 707 can perform the following procedure:

timeOffsetᵣ[j]=timeOffsetᵣ[j]+time_offset,trgIdx−1≧j≧0,

where the value time offset is the time offset of the signal pair, timeOffsetᵣ describes the time offset of each signal for row r and trgIdx describes the second signal index within the selected row (where for example the indexing starts from zero). In it is determined that it is the second signal that is to be delayed with respect to the first signal the delay updater can perform the following procedure:

timeOffsetᵣ[trgIdx]=time_offset.

The pairwise matcher 501 can further comprise a pair checker 709. The pair checker determines whether or not there are any signal pairs still existing for the selected row. Where there is such pairs identified the processing can continue in other words the signal selector, time offset determiner, delay updater and such perform a further iteration.

This is shown in FIG. 8 by the step 805 whereby if that there are further pairs left in row R the operation passes to step 802 and if there are no further pairs remaining the operation passes to step 806.

Furthermore the pair checker when determining that there are no further pairs to be checked in a row can further signal to the row selector 701 to select a further row where there are further rows to be processed.

Thus in such embodiments the operations described herein are repeated for each row within matrix X. The operations thus when performed gradually develop a time offset value for each signal that identifies the relative delays between signals. As more instances of time offsets with different signal orders on a pair by pair basis are determined the accuracy of the relative delays between the signals is furthermore improved therefore providing a robust base for further processing and extracting the final time offsets.

The operation of applying pairwise matching is shown in FIG. 6 by step 601.

The pairwise matcher 501 furthermore is configured to continue pairwise matching until all pairs have been processed. The operation of testing whether or not all pairs have been matched process is shown in FIG. 6 by step 602. Where all pairs have not been processed the operation passes back to the application of further pairwise matching in other words passing back to step 601. Where all pairs have been processed the operation passes to the next step 603.

In some embodiments the audio aligner 201 further comprises a statistical determiner 503 the statistical determiner 503 is configured to receive the time offsets generated by the pairwise matching 501 and configured to determine statistical properties of the time offsets. These statistical properties are then passed to the outlier remover 505. In other words there can in some embodiments comprise: means for determining, or an outlier determiner configured to determine, at least one time offset value is an error value at least one time offset value is an error value, and means for removing, or an outlier remover configured to remove, the at least one time offset value error value.

In some embodiments the statistical properties determined are the mean and variance of the time offsets. These can be determined for example according to following pseudo-code

| | |
|---|---|
| 1 | mean = vector of size N |
| 2 | var = vector of size N |
| 3 | |
| 4 | for(i = 0; i < N; i++) |
| 5 | { |
| 6 | mean[i] = 0.0f; |
| 7 | for(k = 0, nCount = 0; k < R; k++) |
| 8 | if(timeOffsetₖ[i] != −1) |
| 9 | { |
| 10 | nCount++; |
| 11 | mean[i] += timeOffsetₖ[i] |
| 12 | } |
| 13 | mean[i] /= nCount; |
| 14 | |
| 15 | var[i] = 0.0f; |
| 16 | for(k = 0; k < R; k++) |
| 17 | if(timeOffsetₖ[i] != −1) |
| 18 | var[i] += \|mean[i]−timeOffsetₖ[i]\| |
| 19 | var[i] /= nCount; |
| 20 | } |

Where the lines 6-13 determine the mean time offset of i^{th} signal (mean[i]). Furthermore as shown in line 8 invalid time offset values, such as time offset values equal to −1 are considered not valid and are not included in the calculation process. The lines 15-19 in the above example determine or calculate the variance of the time offset for the i^{th} signal (var[i]). The variance in this example is calculated as an absolute difference between the mean time offset and the time offset of the signal. The mean time offset therefore in this example describes the average time offset of the i^{th} signal and the associated variance the time interval, that is, the minimum and maximum time offset for the corresponding signal.

The operation of calculating statistical properties is shown in FIG. 6 by the step 603.

Furthermore in some embodiments the audio aligner 201 comprises an outlier remover 505. The outlier remover 505 is configured to remove any outlier values from the statistic time offset results based on the statistical properties generated by the statistical determiner 503.

In some embodiments the time offset values that are considered outlier values can be removed using the pseudo-code described herein

| | |
|---|---|
| 1 | refIdx = 0; |
| 2 | meanMin = 1E+15f; |
| 3 | |
| 4 | for(i = 0; i < N; i++) |
| 5 | { |
| 6 | do |
| 7 | { |
| 8 | isRemoved = 0; |
| 9 | |
| 10 | “Calculate mean and variance according to pseudo-code 1” |
| 11 | |
| 12 | for(k = 0; k < R; k++) |
| 13 | if(var[i] > varThr && timeOffsetₖ[i] != −1) |
| 14 | if(timeOffsetₖ[i]> mean[i]+var[i] \|\| timeOffsetₖ[i] |
| | < mean[i]−var[i]) |
| 15 | { |
| 16 | isRemoved = 1; |
| 17 | timeOffsetₖ[i] = −1; |
| 18 | } |
| 19 | |
| 20 | } while(isRemoved); |
| 21 | |
| 22 | if(meanMin > mean[i]) |
| 23 | { |
| 24 | meanMin = mean[i]; |
| 25 | refIdx = i; |
| 26 | } |
| 27 | } |
| 28 | “Update mean values according to pseudo-code 1” |

In such example pseudo code line 10 determines the mean and variance of the i^{th} signal such as described above herein. Furthermore according to the above example pseudo code lines 12-18 determine which time offset instances of the i^{th} signal exceed a time offset threshold value. This threshold can in some embodiments be twofold. Firstly, the threshold in some embodiments can tested against the time offset variance of the signal such that the time offset variance of the signal exceeds the variance threshold value varThr (shown in line 13). Secondly, the threshold in some embodiments can tested against the time offset of the signal such that the time offset of the signal either exceeds the sum of the average and the variance time offset (that is, the maximum time offset estimate), or is below the difference of average and the variance time offset (that is, the minimum time offset estimate) (as shown in line 14). When these two conditions both hold the corresponding time offset is excluded from further processing as the value is considered an outlier value (as defined in line 17). The variance threshold, varThr in line 13, can be in some embodiments an implementation dependent variable but is typically closely linked to the underlying signals. For example, in some embodiments the threshold may be constructed in such way that it represents certain time interval. For example where the sample rate of the signal is Fs Hz and the threshold is set to be 40 milliseconds, the varThr would then translate into: varThr=(40/1000)* Fs. The outlier removal process can be performed in some embodiments until no further instances of time offsets are removed (as defined by lines 6-20). In the example pseudocode shown in lines 22-26 the minimum average time offset and the associated signal index are determined. Then as shown in the example pseudocode line 28 the mean and variance values for each signal are updated. In other words in some embodiments there can comprise means for generating, or an offset averager configured to generate, an average offset value associated with an audio signal, means for determining, or an offset difference generator configured to determine, a difference between the error time offset value and average offset value associated with the audio signal, and means for comparing, or an offset comparator configured to compare, the difference against a difference threshold; and means for determining, or a delay determiner configured to determine, the at least one time offset value is an error value when the difference value is greater than or equal to the difference threshold.

The operation of removing the outliers is shown in FIG. 6 by step 604.

Furthermore the audio aligner 201 comprises a minimum delay determiner and shifter 507. The minimum delay determiner and shifter 507 is configured to determine the minimum delay content in other words determining the reference signal. In other words in some embodiments there can comprise means for determining a leading audio signal dependent on the each of the pairwise selection audio signal time offset value, wherein the leading, or reference audio signal leads the other audio signals. In some embodiments the means for determining a leading audio signal dependent on the each of the pairwise selection of audio signal time offset values may comprise means for selecting the audio signal with a smallest associated time offset value.

The minimum delay determiner and shifter 507 can in some embodiments determine the reference signal, that is, the signal with the minimum delay based on the value of refIdx determined by the outlier remover as shown in the pseudo-code herein. The signal corresponding to this index can in some embodiment be set to be the reference signal that has zero time offset by the minimum delay determiner and shifter 507.

The minimum delay determiner and shifter 507 operation is shown in FIG. 6 by step 605.

The audio aligner 201 furthermore comprises a remaining delay determiner and shifter 509. The remaining delay determiner and shifter 509 is configured to determine the delays associated with the remaining audio signals once the reference signal has been determined. In other words the apparatus may further comprise means for determining, or the delay determiner is further configured to determine, a timing offset value associated with each of the audio signals with respect to the leading or reference audio signal.

The remaining delay determiner and shifter 509 can then determine the time offset for the remaining signals from the difference of the average time offset of the signal and the time offset of the reference signal. For example by using the refIdx value such as shown in the following expression:

tᵢ=min(0,tᵢ−t_{refIdx}),0≦i≦N,

where min( ) returns the minimum of the specified samples.

The operation of determining the remaining content delay is shown in FIG. 6 by step 606.

Thus in at least one of the embodiments there can be an apparatus comprising: a pairwise selector configured to organise at least one pairwise selection of each of at least two audio signals; a comparator configured to determine for each of the at least one pairwise selection audio signals a time offset value associated with each audio signal; and a delay determiner configured to determine a leading audio signal dependent on the each of the pairwise selection audio signal time offset value, wherein the leading audio signal leads the other audio signals.

Although the above has been described with regards to audio signals, or audio-visual signals it would be appreciated that embodiments may also be applied to audio-video signals where the audio signal components of the recorded data are processed in terms of the determining of the base signal and the determination of the time alignment factors for the remaining signals and the video signal components may be synchronised using the above embodiments of the invention.

In other words the video parts may be synchronised using the audio synchronisation information.

It shall be appreciated that the term user equipment is intended to cover any suitable type of wireless user equipment, such as mobile telephones, portable data processing devices or portable web browsers.

Furthermore elements of a public land mobile network (PLMN) may also comprise apparatus as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-57. (canceled)

58. Apparatus comprising at least one processor and at least one memory including computer code, the at least one memory and the computer code configured to with the at least one processor cause the apparatus to at least:
perform at least one pairwise selection of each of at least two audio signals;
determine for each of the at least one pairwise selection audio signals a time offset value associated with each audio signal; and
determine a leading audio signal dependent on the each of the pairwise selection audio signal time offset value, wherein the leading audio signal leads the other audio signals.

59. The apparatus as claimed in claim 58, further caused to determine a timing offset value associated with each of the audio signals with respect to the leading audio signal.

60. The apparatus as claimed in claim 58, wherein determine for each of the at least one pairwise selection of audio signals a time offset value associated with each audio signal causes the apparatus to:
determine a relative time offset value between each pairwise selection of the at least one pairwise selection of audio signals; and
determine the directionality of the relative time offset value.

61. The apparatus as claimed in claim 60, wherein determine the directionality of the relative time offset value causes the apparatus to determine which of the pairwise selection of audio signals leads the other.

62. The apparatus as claimed in claim 58, wherein determine for each of the at least one pairwise selection of audio signals a time offset value associated with each audio signal further causes the apparatus to:
determine at least one time offset value is an error value; and
remove the at least one time offset value error value.

63. The apparatus as claimed in claim 62, wherein determine at least one time offset value is an error value causes the apparatus to:
generate an average offset value associated with an audio signal;
determine a difference between the error time offset value and average offset value associated with the audio signal;
compare the difference against a difference threshold; and
determine the at least one time offset value is an error value when the difference value is greater than or equal to the difference threshold.

64. The apparatus as claimed in claim 63, wherein the difference threshold is the variance of the offset values associated with the audio signal.

65. The apparatus as claimed in claim 58, wherein the at least one pairwise selection of each of the audio signals causes the apparatus to:
perform a first pairwise selection of each of the audio signals; and
perform at least one further pairwise selection of each of the audio signals.

66. The apparatus as claimed in claim 65, wherein the first pairwise selection of each of the audio signals causes the apparatus to:
select an initial audio signal from the at least two audio signals;
select a second audio signal from the at least two audio signals to form a pair of audio signals; and
select further pairs of audio signal until each audio signal is selected, where the further pairs of audio signals comprises an audio signal from a previous selection pair of audio signals which leads a further audio signal from the previous selection pair of audio signals.

67. The apparatus as claimed in claim 66, wherein each of the at least one further pairwise selection of each of the audio signals causes the apparatus to:
select a further initial audio signal from the at least two audio signals, wherein the further initial audio signal differs from any previous initial audio signal; and
select a further second audio signal from the at least two audio signals to form a pair of audio signals.

68. A method comprising:
organising at least one pairwise selection of each of at least two audio signals;
determining for each of the at least one pairwise selection audio signals a time offset value associated with each audio signal; and
determining a leading audio signal dependent on the each of the pairwise selection audio signal time offset value, wherein the leading audio signal leads the other audio signals.

69. The method as claimed in claim 68, further comprising determining an timing offset value associated with each of the audio signals with respect to the leading audio signal.

70. The method as claimed in claim 68, wherein determining for each of the at least one pairwise selection of audio signals a time offset value associated with each audio signal comprises:
determining a relative time offset value between each pairwise selection of the at least one pairwise selection of audio signals; and
determining the directionality of the relative time offset value.

71. The method as claimed in claim 70, wherein determining the directionality of the relative time offset value comprises determining which of the pairwise selection of audio signals leads the other.

72. The method as claimed in claim 68, wherein determining for each of the at least one pairwise selection of audio signals a time offset value associated with each audio signal further comprises:
determining at least one time offset value is an error value; and
removing the at least one time offset value error value.

73. The method as claimed in claim 72, wherein determining at least one time offset value is an error value comprises:
generating an average offset value associated with an audio signal;
determining a difference between the error time offset value and average offset value associated with the audio signal;
comparing the difference against a difference threshold; and
determining the at least one time offset value is an error value when the difference value is greater than or equal to the difference threshold.

74. The method as claimed in claim 73, wherein the difference threshold is the variance of the offset values associated with the audio signal.

75. The method as claimed in claim 68, wherein organising the at least one pairwise selection of each of the audio signals comprises:
organising a first pairwise selection of each of the audio signals; and
organising at least one further pairwise selection of each of the audio signals.

76. The method as claimed in claim 75 wherein the organising the first pairwise selection of each of the audio signals comprises:
selecting an initial audio signal from the at least two audio signals;
selecting a second audio signal from the at least two audio signals to form a pair of audio signals; and
selecting further pairs of audio signal until each audio signal is selected, where the further pairs of audio signals comprises an audio signal from a previous selection pair of audio signals which leads a further audio signal from the previous selection pair of audio signals.

77. The method as claimed in claim 76, wherein organising each of the at least one further pairwise selection of each of the audio signals comprises:
selecting a further initial audio signal from the at least two audio signals, wherein the further initial audio signal differs from any previous initial audio signal;
selecting a further second audio signal from the at least two audio signals to form a pair of audio signals; and
selecting further pairs of audio signal until each audio signal is selected, where the further pairs of audio signals comprises an audio signal from a previous selection pair of audio signals which leads a further audio signal from the previous selection pair of audio signals.
